(19) United States
(12) Patent Application Publication
(10) Pub. No.: US 2011/0239200 A1
(43) Pub. Date: Sep. 29, 2011

(54) METHOD FOR COMPILING A COMPUTER PROGRAM

(75) Inventor: Henri Binsztok, Paris (FR)

(73) Assignee: MLstate, Paris (FR)

(21) Appl. No.: 13/012,971

(22) Filed: Jan. 25, 2011

Related U.S. Application Data
(63) Continuation-in-part of application No. PCT/EP2009/058892, filed on Jul. 13, 2009.
(60) Provisional application No. 61/426,653, filed on Dec. 23, 2010.

(30) Foreign Application Priority Data
Jul. 25, 2008 (FR) 08 55135

(51) Int. Cl. G06F 9/45

(52) U.S. Cl. 717/140

(57) ABSTRACT

The invention relates to a method for compiling a computer program written in a high-level programming language. In some examples, the method includes: a preliminary step of writing said program written in a high-level programming language including: a step of building a so-called PML functional basic language with reduced algebra and without re-allocation operations; a step of writing at least one library in a pre-existing language and, from said at least one library, the step of building functional interfaces from imperative functionalities be-longing to the group that includes at least: the perennial storage of information on a medium, the transmission and reception of packets on a network, and the analysis of a data flow; a step of building a high-level language by linking said interfaces in PML language functions; and a step of creating said computer program from the high-level language that includes a compilation step.

### CROSS-REFERENCE TO RELATED APPLICATIONS

This application is a continuation-in-part of PCT Application PCT/EP2009/058892, titled “PROCEDE DE COMPILATION DE PROGRAMME INFORMATIQUE,” filed on Jul. 13, 2009, claiming the benefit of French Application No. 08 55135, filed on Jul. 25, 2008. These applications are incorporated herein by reference.

This application claims the benefit of U.S. Provisional Application No. 61/426,653, titled “SAFE AND SECURE PROGRAMS WITH PERSISTENT DATA,” filed on Dec. 23, 2010. This application is also incorporated herein by reference.

### BACKGROUND

The present invention relates to creation (e.g. compilation) of computer programs.

A computer program is, strictly speaking, a series of instructions executed by a computer, either by interpretation or by compilation. However, in the present application, we understand a program in the extended sense of a series of instructions for any kind of hardware containing microprocessors or microcontrollers. Indeed, with adaptations available to any person knowledgeable in the art, the invention is also applicable to the programming of programmable electronic components and to the design of classical electronic components. The description of the invention is more clearly understandable when explained with the example of software applications, therefore the text of the present application illustrates the invention essentially in the domain of software applications. In the rest of the present application, we concentrate on software programs providing web services. It is, however, clear that the invention is not limited to this particular application, but can also be used for instance in the domain of the construction of computer operating systems or more generally in any case where any of the following objectives is pertinent: provability of computer programs, persistence of data, optimization before execution, development environments, flexible use of several syntaxes.

The problems of computer safety related to software bugs and the problems of computer security related to the exposure of software to attacks through networks take a growing importance. The cost of these problems is estimated at several billions of euros per year, for the sole European Union, and they affect not only customers but also companies and citizens. In the domain of web servers, it is estimated that more than 80% of websites offer flaws that can affect critical user data.

For this reason, numerous actors have committed to the development of solutions with objectives of quality and safety of applications and security of networks. These solutions range from the definition of development processes materialized by certifications expected to guarantee a level of trustworthiness, such as the CMMI certification (or “Capability Maturity Model Integration”), to the use of testing software expected to find out, through brute force, a significant fraction of the many errors that ay appear in an application. Whenever computer software must be integrated into programmable electronic components, programming errors are also integrated in these components, which may also cause security issues.

### SUMMARY

One or more aspects for the invention are summarized below. Reference to aspects or characteristics of the “invention” should be understood to refer to only one or more embodiments of the invention, and should not be understood to be required characteristics of all embodiments.

The present invention is a process of compilation for computer programs written in a high-level programming language.

According to the invention, the method comprises:
a preliminary phase, prior to writing said program in said high-level programming language, consisting in:
   a step of construction of a core functional programming language with reduced algebra, without re-assignment operations—we will call this language PML for the rest of this document;
   a step of construction of at least one library in a preexisting language, followed by, using said at least one library;
   a step of construction of functional programming interfaces from imperative features belonging to a group containing at least:
      long-term storage of data on some support;
      sending and receiving packets on a network;
      analysis of a data stream.
   a step of construction of a high-level programming language by binding of said functional programming interfaces into functions of PML;
a phase of creation of said computer program from said high-level programming language, comprising one step of compilation.

According to one particular characteristic of the invention, the step comprising the construction of functional interfaces also comprises a step of storage of at least one instruction of said high-level programming language associating to a command name a set of at least two commands of said PML language, and the phase comprising the creation of said computer program from said high-level programming language also comprises a step of storage of said computer program, whereby said compiled computer program makes use of at least one of said stored instructions.

In another embodiment, said phase of creation of said computer program also comprises one step of integration of said created computer program in an electronic or computing hardware component.

Thus, the invention permits creation of electronic hardware components that are guaranteed as exempt of bugs. Said components may for instance be diodes used to produce a conformity result depending on an input parameter.

According to one particular characteristic of the invention, said computer program written in a high-level programming language is an XML parser and said imperative feature of analysis of a data stream is a feature of analysis and verification of a XML file.

In an original embodiment, the invention comprises a set of primitives for specifying access to data in a database in the high-level language, permitting said long-term storage of information on some support without requiring that a third-party application is required for managing a database.

According to one particular characteristic of the invention, data, data structures and states of applications of said computer program are made persistent by the use of at least one data structure with the same representation in memory and on a storage device.

In an original embodiment of the invention, said phase of creation of said computer program also comprises one step of static analysis of source code of said computer program, before compilation, so that said computer program is optimized and/or proved formally.

In an original embodiment of the invention, said phase of creation automatically determines which indices to generate in order to respond to implicit requests to the database. By opposition to existing computer languages for which requests must be written and optimized manually by a programmer, the process of the invention relies on a unified, high-level programming language which specifies the application logics and handles access to the database in a manner that is both natural and transparent, with similar data structures in memory and on the disk.

According to one particular characteristic of the invention, said at least one library permits implementing at least one feature absent from said language PML and use of said at least one library by said computer program allows the conservation of properties of said language PML, such as characteristics belonging to a group comprising at least:
the functional programming characteristic of said language;
the provability of said language;
the persistence of manipulated data.

In an original embodiment of the invention, at least one of said libraries permits handling of network exchanges by integrating at least two primitives for reading and writing data on communication port and said produced computer program is a web server application.

In a specific embodiment of the invention, the process comprises the construction of a single executable binary compiled from a single source language and said single executable binary generates code, including HTML, CSS and JavaScript code, as well as compiled requests for accessing data. Said HML, CSS and JavaScript code can be validated during compilation.

According to one particular characteristic of the invention, said process also comprises one step of construction of a language of specifications that does not have functional characteristics and programs coded in this language are compiled towards said high-level programming language.

Moreover, the invention pertains to an apparatus of compilation of a computer program written in a high-level programming language. According to the invention, said program comprises:
means for creation of said high-level programming language, comprising:
   means of construction of a core functional programming language with reduced algebra, without re-assignment operations;
   means of construction of at least one library in a preexisting language, followed by, using said at least one library;
   means of construction of functional programming interfaces from imperative features belonging to a group containing at least:
   long-term storage of data on some support;
   sending and receiving packets on a network;
   analysis of a data stream.
   means of construction of a high-level programming language by binding of said functional programming interfaces into functions of PML;
means of creation of said computer program from said high-level programming language, comprising one step of compilation.

Thus, a compiler according to the present invention permits creation of computer programs that may be integrated as part of electronic devices and for which it may be ensured that no bugs are present.

In a specific embodiment of the invention, said apparatus comprises in addition means of integration in an electronic or computing hardware component of both said created computer program and means for associating an output of the electronic component to a filter or a converter component.

According to a particular characteristic of the invention, said computer program is implemented as part of the electronic component, which may be a programmable electronic component such as a FPGA.

Therefore, the invention is based upon mechanisms that allow using the same language to define treatment of both the data of the program itself and the data manipulated by the program, whether said data is stored in memory, on a hard drive or on some other form of long-term storage device.

The use of a high-level programming language improves consistency and expressiveness and reduces redundancy of code. Moreover, it limits risks of introducing bugs while coding and facilitates automated analysis of programs, proof of programs and optimization of programs.

The process according to the invention permits in particular the construction of products—computer programs and internet services—with the two following properties: long-term storage of information and provability. The meaningfulness and technical value of both properties, as well as the innovative manner of guaranteeing them, will appear in the reading of the process according to the invention.

As will be exposed, construction through the process according to the invention of computer programs written in unified programming languages removes restrictions of redundancies of variables and functions and offers syntactic flexibility that improves expressiveness and permits very agile development. The process according to the invention offers a large array of innovative characteristics which provide major technical improvements to the programs written in a high-level programming language, in particular in their manner of managing long-term data storage, transmission of data over the network and validation of a data stream.

In particular, this process permits, from a unique source code written in a high-level programming language, generating a unique program in machine code that can manipulate data.

Thus, the invention is based upon a very innovative and inventive approach of creation of computer programs.

Moreover, the invention pertains to a process of construction of computer programs, characterized insofar as it comprises the following steps:
construction of a programming language and a database, where said database comprises features of management of long-term persisted data inside the physical memory of an apparatus;
integration of a set of primitives allowing access to data of said database in the programming language permitting the obtaining of a high-level programming language;
development, using said high-level programming language, of a program resulting in a unique application that does not necessitate access to the data of sad database through a separated application.

In an advantageous embodiment of the process of the invention, data, data structures and states of the application are made persistent by the use of data structures of the same type in memory and in the long-term storage.

In particular, the programming language serving as base for the high-level programming language is a functional programming language, for instance a language with a reduced algebra and without side-effects. Use of such a functional programming language simplifies the obtaining of proofs but it must be noted that, fundamentally, an equivalence exists between functional programming languages and imperative programming languages and that a man of the art can apply the process of the invention to an imperative programming language.

In an advantageous embodiment, programs constructed are compiled and not interpreted. The source code of the program is analyzed statically before compilation and, through this analysis, the program is optimized and/or proved.

In order to add features to programs written in a high-level language, the invention calls upon the construction of modules. Such precompiled modules implement and encapsulate in particular imperative features. Through this mean, the resulting program keeps essential characteristics of the high-level programming language (depending on the embodiment, respectively functional programming and/or provability and/or long-term storage) while extending its field of application.

An example of such an extension of the features of a program by incorporation of a module is a network module, constructed by integrating at least two elementary primitives such as read socket and write socket. The program produced is a Software as a Service. The invention therefore permits construction of internet services.

According to a particular embodiment, the invention relates to the construction of a language of specifications (SL). Said language does not have functional programming properties, which makes it easier for non-programmers. However, said language is built from a functional programming language such as QML and programs written in SL are verified and compiled towards a functional programming language AML, before being translated into QML, which permits the conservation of provability and long-term storage of programs, although the code of said programs remains very readable.

The invention also relates to the construction of a parser. In particular, a parser for the XML language is built from language PML. In this particular embodiment, the invention does not make use of a database and long-term storage is not a property of constructed programs. The main desired property is provability. This property is obtained by construction.

From a functional programming language with a reduced algebra and using a grammar, a meta-grammar, parsers and compilers and an intermediate representation of the XML language, for instance as a stack, one may build an XML parser with less than 500 lines of code. Said parsing programs, which may easily be proved thanks to the small code size, may be used on computers or on electronic devices, including programmable electronic components such as FPGA or CLPD. They maybe used alone or associated to other components, in particular filters or converters.

Any program constructed by the process according to the invention is, by construction, adapted to automated analysis. A particular characteristic according to the invention is that these analyses are not restricted to the proof of correction of the code but also to the evaluation of temporal characteristics of the program. Results obtained by some of these analyses—for instance the statistical distribution of the duration for treating an arbitrary input signal—are extremely useful for real-time applications.

Programs constructed by the process according to the invention are not limited to a single computer or to a computer. In particular, with adaptations well-known to a man of the art, products containing microprocessors, such as mobile phones, <<triple play>> boxes or other television-connected devices, on-board car computers, devices for controlling machine tools or factories—this list is not exhaustive—can make use of programs obtained by the process according to the invention, and be improved by the advantageous properties of said programs, in particular the properties of provability and long-term storage.

Moreover, the invention relates to a process of compilation of a functional programming language LH into software applications. According to the invention, such a process comprises:
a step of definition of a prototype for functional databases, whereby said prototype is designed to be verified through means of formal verifications;
a step of definition of a typed functional programming language QML;
a step of integration of said prototype of functional database in said typed functional programming language QML through a specific interface of said prototype and a specific type of said language, whereby said integration step delivers a functional programming language LH.

Thus, the invention is based on an approach that is both innovative and inventive for creation of computer programs, insofar as it allows writing of a program by the means of a functional programming language based on a very reduced algebra and the possibility of integrating a database directly in the language.

Therefore, the invention permits the construction of a formal proof of a program thanks to the use of a functional programming language with a reduced algebra. Said language makes it easier to prove, before even the compilation or linking of the program, that the program works correctly and without any bug. Therefore, the invention removes the need for testing the program once it has been compiled.

In a specific embodiment according to the invention, said process also comprises one step of generation of a compiler from said functional programming language LH to an existing programming language.

According to a particular characteristic of the invention, said process also comprises a step of integration in said typed functional programming language QML, of at least one module of formal verification of said functional programming language LH.

According to a specific embodiment, said process also comprises a step of integration in said typed functional programming language QML of at least one module for helping creating specific applications.

Therefore, the invention permits the use of libraries of precompiled code, presented as part of the language, to make use of certain features that are either too complex for a functional programming language or have been implemented as part of a distinct grammar of functional programming language and that may therefore be integrated in the final functional programming language. Said features may be, for instance, specific parsers such as HTML or XML parsers.

According to a particular characteristic of the invention, said prototype of functional database comprises mechanisms for managing long-term storage of data.

Therefore, the invention permits, thanks to the integration of the prototype of database in the typed functional programming language QML, to offer natively long-term storage of data. The invention not only allows mechanisms for persistence for data related to the application (e.g., for a wiki, the content of pages) but also persistence of the application itself, that is to say, its state (its internal data, variables, etc.)

In another aspect, in general, a method for checking static properties on programs manipulating persistent data comprises
(a) providing a programming language
(b) providing a persistent data storage
(c) said persistent data storage being integrated as a part of said programming language
(d) providing a static analysis on programs written in said programming language
(e) said static analysis detecting errors about said programs and persistent data

whereby a developer can manipulate persistent data easily and be warned at compilation time in case of errors in the source code of the developed application.

Aspects may include one or more of the following.

The static analysis comprises type-checking

The static analysis comprises a verification of formal properties. For instance, the formal properties comprise integrity constraints. In some examples, the formal properties comprise integrity invariants. In some examples, the formal properties comprise functional specifications.

In another aspect, in general, an apparatus for building certified applications possibly involving a persistent storage comprises:
(a) a programming language
(b) a persistent data storage
(c) said persistent data storage being integrated as a part of said programming language
(d) a source code written in said programming language
(e) a compile-time analyser detecting errors in said source code
(f) an application
(g) a compiler or interpreter of said source code producing said application

whereby the resulting application is certified according to a formal specification offering safety and security guarantees to the user

Aspects may include one or more of the following:

The programming language includes polymorphic extensible records and pattern matching on said records.

The persistent storage is a hierarchical database comprising (a) nested records and (b) maps containing sub-parts of the database indexed by values of a given type.

The analyser is a type-checker.

The analyser is a program verification tool.

The application manages accounts.

The application manages bank accounts.

The application is a prepaid mobile card management system.

An advantage of one or more of the embodiments is that they can make it possible to develop easily certified applications involving a persistent storage such as web applications. One or more embodiments can be used in an account management system, which can be viewed as a base for banking web applications or prepaid mobile cards systems using billing rules.

Other features and advantages of the invention are apparent from the following description, and from the claims.

### DESCRIPTION OF DRAWINGS

FIG. 1 illustrates differences between the state of the art and the development in a Web application in AML.

FIG. 2 summarizes the principal stages of construction, by incorporation of modules, advanced languages (QML, AML then SL) starting from a functional language with reduced algebra (PML).

FIG. 3 illustrates the flow of the code written in language of specification SL then checked and compiled in AML, QML then PML.

FIG. 4 illustrates the principle of the construction of an XML parser for the PML language.

### DESCRIPTION

Part 1

1.1. Principle of the Invention

The invention relates to a new process for creating computer programs containing fewer or no bugs. The process is based in particular, in a specific embodiment, on the unification within a single language of a both database specifically constructed to deal with problems of functional and imperative programming, a language for placing requests to this database, and a general-purpose language with reduced algebra, to implement application logics.

We note that certain recent projects such as Microsoft's LINQ aim to offer a native syntax to programming languages Visual Basic and C# to perform requests to a database. Similarity with the invention, however, is very superficial. Indeed, LINQ instructions in a Visual Basic (or other) program are translated to SQL or another classical request language. The database is not included in the programming language and the program is therefore not unified: a main application manages variables, functions, etc. while a dedicated application manages the database itself, its tables, relations, fields, etc. While LINQ partially hides this coexistence, such construction does not allow a real integration of the database in the program and does not offer the numerous advantages related to the complete integration of the database in the program obtained by the process according to the invention, in particular the provability of said program, the optimization of data structures from their use or the long-term storage of data and data structures.

To understand the contribution of the invention, one must explain long-term storage of data. Long-term storage of data relates to the mechanism in charge of saving and restoring data, so that a program may stop at any moment without causing loss of data. The classical approach is to let specific software interface with a database management system through standard protocols. Such software includes Toplink, JDO or Hibernate.

The invention allows long-term storage of data in a unified programming language. This unified functional programming language is then used to write specific programs such as web applications, accounting applications or any other form of computer program. Said programs integrate directly long-term storage, in the broad sense of long-term storage of data, data structures or program states—who are themselves stored in the database—as well as other properties associated to other characteristics of the invention, as described in this document.

In a preferred embodiment, the process according to the invention uses a functional programming language with a reduced algebra, as well as several precompiled modules who have been proved beforehand.

In at least one embodiment, the process according to the invention is characterized by the identity between the data structures used for storage and manipulation of data and the storage of data on the storage device. Storage is not restricted to tables and more advanced structures may be used, including tree data structures both in memory and on the storage device. Optimizations are possible for storage space, contiguous read time, access time to non-contiguous data, or distinct storage mechanisms (memory, flash drivers, hard drives, DVD, . . . ). This innovative characteristic of the process according to the invention permits persistency of data. Several types of tree data structures can be used, including structures such as Patricia maps, known to a man of the art.

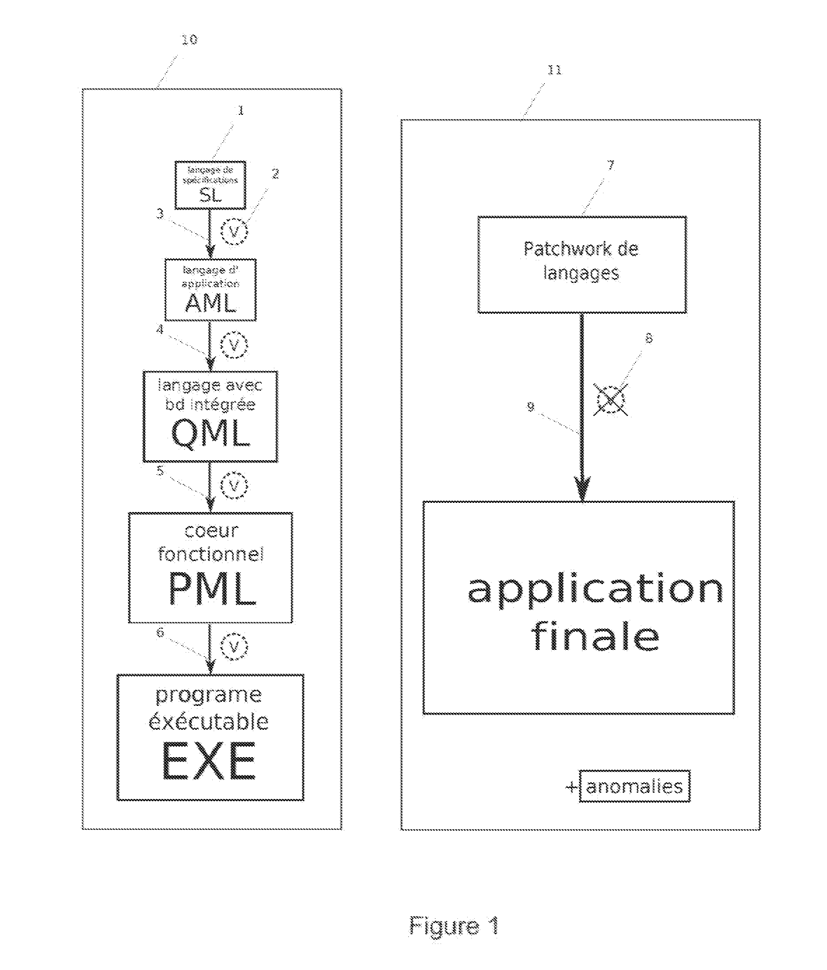

FIG. 1 illustrates the process for constructing a source code for the program of a web application, in two cases of the FIGS. (10 and 11). In the first case, the program is written from specification language SL (10). In the second case, the program is written with classical tools (11).

In the first case (10), a program (1) expressing in a language closed to natural language the specifications of data and of the application is first verified (2), then compiled (3) in an application language AML. The AML code is also verified, as well as the HTML, CSS and JavaScript generated automatically from this AML code, and is then compiled (4) to the QML language with its integrated database. The QML code is verified and compiled (5) into a functional programming language with reduced algebra PML. This final code is verified and compiled (6) either directly or indirectly (for instance by translation to C or OCaml) in an executable program.

In the second case (11), a web application is produced with techniques belonging to the state of the art: we start from a set of at least three languages, the code is not verified (8) and is not successively compiled. A patchwork of languages and configuration files (7) is used to produce (9) an executable which may contain numerous bugs.

Compared to the state of the art, a program written in the specification language SL is particularly short (few lines of code). Another advantage of this embodiment according to the invention is that the web application is much lighter (it uses little memory).

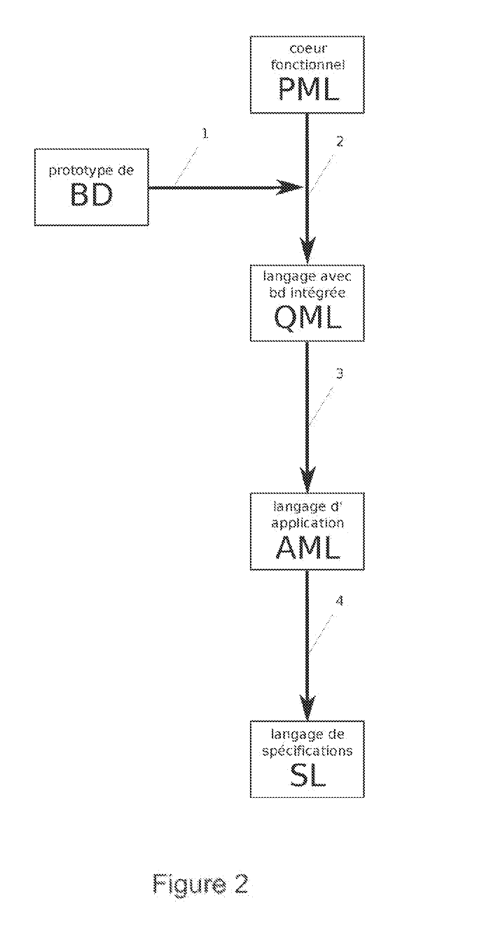

FIG. 2 represents the construction of high-level programming languages (such as SL, which we will use for the rest of this document) from a functional programming language with a reduced algebra PML (core language). Firstly, a module encoding the imperative database features (in particular two primitives to read and set data) is merged with the language (1). A step of bootstrapping is necessary for the complete incorporation of the database into the language (2). We thus obtain, according to the invention, a language merged with a database (QML). By merging (3) another module encoding network communication (in particular, two primitives for receiving or sending data on a network socket), we obtain, according to the invention, a web application language (AML). By modifying (4) the syntax of AML through classical rewriting mechanisms, we obtain a high-level programming language close to natural language (SL) which allows a non-programmer to write the specifications of the application.

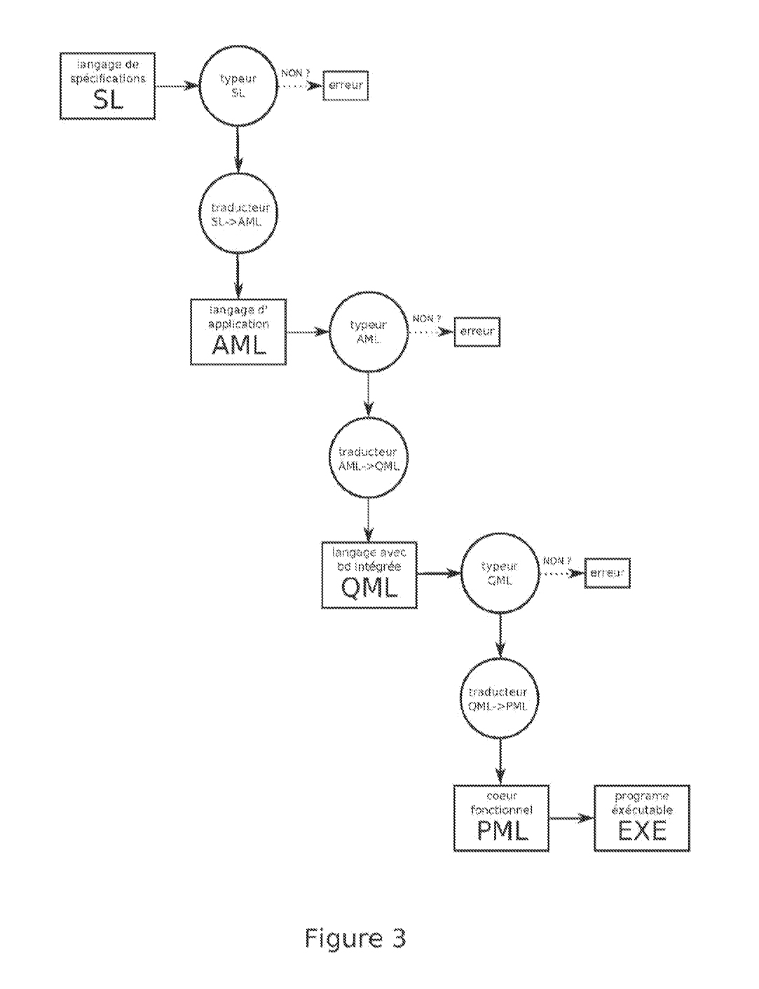

FIG. 3 illustrates in more detail the process for constructing the source code of the program of a web application described in FIG. 1, with specification language SL.

The phases of verification and compilation are embodied by the typer and the translator. At each step, the type may detect errors, such as coding errors, in which case it produces an error output, for instance when the syntax tree is incorrect. If no error is detected, a translator is used to produce a source code in an intermediate language (AML, then QML) and finally in the core language PML. This final code is verified and compiled into an executable program or a code that may be inserted in a programmable electronic component.

Through the successive verifications and the character of provability of the source code in each intermediate language as well as in the core language, the invention guarantees that the final executable program is free of bugs and anomalies, by opposition to programs produced according to the state of the art. Therefore, the invention guarantees that a program inserted in a software programmable component is free of bug and will not made fragile or vulnerable to attacks because of programmer errors.

1.2. Embodiment: Creation of SaaS Applications with AML

1.2.1. Construction of the Prototype of a Database

A significant part of the technical interest of the invention resides in the integration between a program and a database. We describe how to construct a prototype for a database that will subsequently be integrated in a high-level programming language.

In a specific embodiment, the functional database according to the invention is constructed by a set of graphs and tables mapping a low-level internal path p in a eid, which identifies uniquely an element in the database. Another table maps each eid to an uid. After each update of data in the base, the eid remains unchanged but a new uid is created. Each uid gives access to a single piece of data d in the database. Searching for a specific piece of data in the database is therefore implemented by mapping p→₁eid→₂uid→₃d.

In this specific embodiment, the database is stored to memory. However, according to the invention, they may be written to a hard drive. The functional programming characteristic of language QML is well-suited to a form of long-term storage in which data is stored on the hard drive. We detail one of the techniques which may be used for this long-term storage to drive.

The hard-drive component of each database is implemented as at least four files, all of them in append-only mode, that is data may be added at the end of a file, but never modified. When logically removed, data is not removed from a file, which both improves security and permits efficient usage on hardware devices that limit writing, such as hard drive append-only firmware.

The four files are the following:
one file (dbc) stores the uid counter;
one file (dbu) stores mapping as a tree;
one file (dbt) stores the data, that is mapping as a tree;
one file (dbr) stores revision numbers.

In variants, the same information can be written with a larger or smaller degree of redundancy on several files. For instance, file dbc may be removed altogether, or the contents of dbr may be split or replicated among several files.

A data structure of patricia maps is particularly appropriate for mapping. For performance, a man of the art may add several optimizations. Depending of applications, other more usual data structures can be used, such as patricia trees or binary recursive trees.

1.2.2. Integration of the Database in a Functional Programming Language with Reduced Algebra PML and Construction of a New High-Level Programming Language QML

To produce a high-level programming language permitting the creation of programs exempt from bugs, according to the invention, one needs a functional programming language denoted PML which, once merged with the database, will produce language QML.

Language PML according to the invention is a language of the ML family (Damas, L. and Milner R., Principal type-schemes for functional programs, Annual Symposium on Principles of Programming Languages, 1982). The inventors have had the ingenious idea of extending the expressiveness of the language while simplifying the language itself. Thus, language PML innovates with respect to ML, by:
introducing polymorphic and extensible records;
implementing sum types as record types through the use of named types;
removing redundant constructions including booleans, conditionals, modules.

The algebra and expressions of language PML are reduced to:

```
type expr =
        | Const of K.expr
        | Ident of ident
        | Coerce of expr * typeexpr
        | Lambda of ident * expr
        | Apply of expr * expr
        | LetIn of ident * expr * expr
        | LetRecIn of (ident * expr) list * expr
        | ExtendRecord of string * expr * expr
        | Dot of string
        | Match of expr * (pattern * expr) list
and typeexpr =
        | TypeConst of K.typeexpr
        | TypeVar of typevar
        | TypeName of string * typeexpr list
        | TypeArrow of typeexpr * typeexpr
        | TypeRecord of typeexpr Records.t
and pattern =
        | PatField of string * pattern * pattern
        | PatConst of K.expr
        | PatVar of string
        | PatAny
```

This language PML is characterized by a reduced algebra, insofar as the algebra of expressions (type expr= . . . ) is small: ten in this embodiment. We say that an algebra is reduced if it has less than 20 constructors.

We do not detail expressions for records, which are based on binary trees, or constants, in particular integers, floating point numbers, character strings and null values.

We could decide to limit identifiers to character strings (value names), as is done classically. However, we decide otherwise, since the invention introduces a novel technique for identifiers introduced in expression and type algebras, which permits better security guarantees in the implementation. For this purpose, the algebra of identifiers is rather:

type ident =
| Source of string
| Internal of abstract

In this definition, abstract denotes an abstract type (e.g. integers) in which distinct values are unique. Using these types permits addressing some problems with α-conversion.

According to the invention, integrating language PML with the previously described database is a complex and novel mechanism. Such integration unifies the language used to describe programs and the language used to described the database. This increases the consistency, avoids redundancy and limits the risk of errors during coding.

The objective is therefore to fully incorporate the database into the language so as to have only one language, instead of two classically. In a preferred embodiment, we perform this integration by enriching the algebra of identifiers presented above.

Enriching Identifiers

The algebra of language identifiers becomes

type ident =
| Source of string
| Internal of abstract
| External of path

In this definition, a path is path, that is a database mapping, as defined previously. The use of such database paths as constructors permits the integration of the database and of all the features of the database, including management of history. Indeed, this mechanism permits constructions such as

let [| /chemin/vers/donnee |] = valeur in ...
let resultat = calcul [|/chemin/vers/donnee |] in ...

These expressions generalize in a simple manner the needs of data access. The example of computations (which may be filtering, sorting or conjunction of requests) may be specified with the specified general-purpose language.

For instance, consider a path representing an association between strings. In the language, we denote such a construction:

val table: string stringmap

To filter this association by selecting all keys which start with letter ‘a’ we write:

val select = fold (fun x y acc -> if x[0] = ‘a’ then y::acc
else acc ) [ ] [| table |]

or, with an abridged notation,

val select=filter[|table|](fun xy->x[0]=‘a’)

Classically, executing of this code on a computer means executing the following steps a runtime (that is, not during compilation):
the association table is loaded to memory, hence transmitted from the storage device to the memory through the bus;
data is examined one by one by the CPU to determine whether they appear in the data structure built in memory.

This scheme is inefficient, as it is faster not to load the complete association in memory. For better performance, the compiler should rather determine that only values matching the filter should be loaded from disk to memory. The invention therefore introduces an innovative and complex mechanism that exploits reduced algebras to determine where the filter should be executed. With this mechanism, executing the same code on a computer entails the following runtime steps:
the set of data is filtered while still on drive, and ensures that only data that matches the criterium is stored in memory;
the data structure thus built is exploited by the rest of the application.

This mechanism is built to construct indices automatically, so as to ensure filtering and sorting of data. The invention is ingenious, insofar as it allows specifying naturally the use of data without having to manage the manner in which data is transmitted during the execution of a program between the hard drive and memory—a process that is costly in terms of execution time.

For each form of treatment that can be automated, we produce during compilation a mechanism for automatically building an index. In the previous example, we construct automatically an index containing all entries of said association in which the key starts with letter ‘a’.

During execution of the application, we make use of said building mechanisms if filtering or sorting operations are frequently used. For this purpose, we introduce a mechanism for counting calls to filtered or sorted sets of data. Whenever the counter passes a predefined value, we build and maintain the corresponding index.

With the objective of extending the mechanism to a system comprising several servers sharing the data whether by replication or by splitting, the inventors have added one information on the source of data, under the form of a list of machines associated to each path. The invention therefore contributes a solution to the problem of distributed applications.

A man of the art will easily notice, by reading the current description, that the elaboration of the package comprising the database and the programming language raises the difficulty of bootstrapping, insofar as the idea is to design a programming language based on a programming language of the same nature. The inventors resolve this issue through the application of the following steps:

1. define language PML, as presented previously, and implement a parser and a verifier for this language;

2. define an interface for the database as a module for the language;

3. apply the database functor to the module defined in the previous step to obtain a database that may store expressions;

4. use said functor to write a compiler from the language towards an existing langue (for instance, OCaml or C) or an interpreter.

The product of this phase is therefore, in this embodiment, a high-level programming language QML that may treat transparently persistent data and create automatically, without user intervention, databases relative to data manipulated by the user in her program and that may be automatically managed by programs created the programming language.

Moreover, the invention comprises mechanisms that allow a grammar describing a language (for instance, language QML) and integration, in this language and from these grammars, of specific modules dedicated to various functions, for instance functions that are implemented by programs written in imperative languages or modules for formal verification. Such modules for formal verification may provide guarantees of absence of bugs in a program, even before the compilation of the program.

Grammar

According to the invention, grammars allow describing languages (for instance language QML) and integrating them according to the process described previously. The inventors have therefore defined a type of grammars of the kind of Parsing Expression Grammar (PEG) languages to develop productions in QML. In such a grammar, the inventors have added the notion of parsing functions, which permits factorization of grammar codes, often redundant.

The following is an n example of grammar, as obtained after parsing of its own syntax:

```
type definition =
{ expression : expression
      ; debug : bool
      ; mark : bool }
  and expression = sequence list
  and sequence = item list * (bool * code) option
  and item =
    [\grave{ }AND | \grave{ }NOT | \grave{ }NORMAL] * primary *
      [\grave{ }QUESTION | \grave{ }STAR | \grave{ }PLUS | \grave{ }NORMAL]
  and primary =
      | Ident of ident
      | Paren of expression
      | Literal of string * bool
      | Class of range list
  type include_type = Incl | Read
  type include_def =
      { it : include_type
      ; gl : string list
        }
    type pre_grammar =
        { pheader : header list
        ; pextra : code_ident list
        ; incl : include_def stringmap
        ; funs : gfun stringmap
        ; defs : definition stringmap }
    and gfun =
        { vars : ident list
        ; expr : expression }
  and header =
        [ \grave{ }inside of code
        | \grave{ }normal of code
        | \grave{ }file of filename
        ]
  type grammar =
  { start : string
  ; grammar : definition stringmap
  ; header : header list
  ; extra : code_ident list
  }
```

A benefit of these grammars is that they may be compiled to several destinations:
a syntax checker-colorizer, which validate an input against a syntax and returns the zones of the input matched by each rule of the grammar—this mechanisms allows creation of a syntax checker, that the inventors have ingeniously merged with an automated colorizer;
a transducer that analyses and produces some code (for instance in QML) depending on the entry;
a verifier in JavaScript, which allows syntax checking on the client in AJAX applications.

Therefore, according to the invention, a unique grammar may be used, without code duplication, for several objectives.

Multiple Syntaxes

According to an extension, the use of grammars defined previously allows one language with several distinct syntaxes. Indeed, each program is stored in memory as on the disk as an abstract syntax tree. If we choose reversible rules, a parser can transform source code into an abstract syntax tree, while a pretty-printer (or “unparser”) can transform values from this abstract syntax tree back to source code. The association to a classical pretty-printer can then provide an environment in which several programmers work with distinct syntaxes while sharing their code. A developer can see the code of another developer with the syntax that best matches her preferences. In particular, this simplifies collaborative work by numerous developers who may not be based in the same country. Activity of each developer can be the object of a statistic analysis for management purposes. For instance, the following table compares two possible syntaxes for QML:

| ML-style syntax | Java-style syntax |
|---|---|
| val fx = x + 1 | function f(x) {x + 1;} |
| val fx = match x with 1 -> | function f(x) {select x; case 1: “ok”; |
| “ok” \|_{—} -> “erreur” | default: “error”}; |

The mechanism for using several distinct syntaxes at once will allow a programmer trained in PHP to use a PHP-like syntax, a programmer trained in Java to use a Java-like syntax, . . . while still sharing code. This mechanism allows extending the potential target of the language. Moreover, this mechanism allows using a specific syntax suited to a specific program or program portion, whenever this syntax improves readability.

Extensible Syntax

A second extension allows integrating an extensible syntax in language QML. Such a mechanism allows developers to extend syntax directly as part of the application. For instance, in the following, keyword syntax describes an extension of the syntax of definition of values in which any definition also calls a function jlog:

val before x = x
syntax <val> <ident> <int>
<ident>* <equal> <expr>
{{ VAL (_2, _4, LetIn(“_”, Apply (“jlog”, _3), _6) }}
val after 2 x = x

In this extract, keyword VAL is part of said extension currently.

Therefore, it is possible to extend the grammar so as to integrate features that are not, initially, supported in the original programming language, and to allow creation of complex applications in a manner simple and exempt of bugs.

Syntax Coloring

The inventors also offer a mechanism for automatically deriving syntax coloring rules for a syntax defined in a grammar language. The process consists in:
introducing a mechanism to derive a unique number from a character string representing the name of a rule;
splitting this number in three parts, in order to associate a number to each color channel (red, green, blue);
selecting the most pertinent rules matched by a zone that are neither too global (insofar as they accept the whole text) nor too specific (insofar as they manipulate only a symbol);
use a mechanism to reinforce the readability of characters presented in front of a colored background (for instance white) by taking into account luminosity and contrast with respect to other rules.

The originality of the invention consists in permitting the coloring by the exact parser of the language and not by an approximation such as is systematically the case in the state of the art. Therefore, a developer can be certain that a code coloring is accurate and cannot be led into error by a coloring which follows rules distinct from that of the compiler.

1.2.3. From Language QML, Constructing a Language AML Dedicated to Development Dynamic Web Applications

Therefore, the invention permits the construction of a programming language QML that allows the creation of programs that, once compiled, exhibit few or no bugs.

According to the invention, language QML serves as base for the construction of a new programming language, named AML (for “Application Meta Language”). AML is a high-level programming language used on top of QML to develop Internet applications. The construction of AML on top of QML is based on techniques already mentioned including the use of modules. AML adds to QML:
an automated interface for web server through a function that returns a character string (using the HTTP protocol) as reply to any request;
the use of a grammar to map from request URLs to functions;
functions for internationalization of character strings (messages) spread among the application code;
a mechanism for reacting to events, that describe the dynamics of the application.

According to the invention, an application is defined as a description of a static component, that describes the initial state of the application, and of the reactions, that transform this initial interface. At any moment, it is possible to store, for instance in the database, the state of the application, for instance for the purpose of restoring immediately a program in the state in which it was when saving. The same set of modifications can be applied: the interface is live.

According to the invention, the code written in the language is compiled and a unique executable is generated. This unique executable contains all the elements of the application, including external resources. The solution introduced by the invention is the only one to integrate this compilation up to the requests to the database that are compiled to machine code. In classical approaches, even when the server itself is compiled, the code for database requests remains in SQL format, interpreted during the execution. This compilation and this integration of all elements as part of the application offers the following advantages in terms of security:
total immunity with respect to SQL injection attacks, which are currently present in numerous internet servers;
total immunity with respect to Buffer Overflow attacks;
immunity with respect to some Cross-Site Scripting attacks.

One of the major interests of AML appears when developing dynamic web applications based on the Ajax technology. Indeed, the programmer does not need to write a single line of JavaScript or to handle technical details of the implementation of Ajax: all the JavaScript code is generated automatically from AML and is validated during compilation.

Therefore, the AML language is based on a EABV model: Event→Action→(Base, View). In this model, each event triggers an action, which may in turn trigger atomic changes into both the database and the user interface. The program is split in slices that are executed on the server and slices that are executed on the client. Various heuristics may be used to optimize slicing, for instance by attempting to minimize the duration of exchanges between the client and the server. Alternatively, more classical models such as MVC may be used.

1.2.4. Example of an Application Written in the AML Language: a Wiki

For instance, we introduce an example program offering the base features of a wiki and that only counts two dozen lines in AML, without any specific library, while any classical approach would require several hundreds of lines of code and configuration to obtain the same result. The executable constructed from language AML only occupies 300 kb, while the same example written with the default solution Linux+Apache+PHP+MySQL occupies ten to hundred times the same amount of space.

```
wikis: string stringmap;;
    counts: int stringmap;;
    save name content = temp = result <- <img src=‘wait.gif’ />;
      x = $content.value;
      c = int_of_string $“countdiv”.value;
      [| “wikis”/name |] = x;
      [| “counts”/name |] = c + 1;
      [ temp; result <- “ok” ];;
    wiki name = default “this is a new page” [| “wikis”/name |];;
    count name = string_of_int (default 0 [| “counts”/name |]);;
    button_content name =
      <a href=$save name “content1”$>save1</a> |
      <a href=$save name “content2”$>save2</a>;;
    page name =
      <h1>$name$</h1>
      <textarea id=“content1”>$wiki name$</textarea>
      <textarea id=“content2”></textarea>
      <div id=“countdiv”>$count name$</div>
      <div id=“machindiv” class=“button”>$button_content
name$</div>
      <div id=“result”/>;;
    <<main>> name = js_page “MLstate wiki :: name” auto_js (page
name);;
    val urls(normal) {{
      “/code.js” {{
      (fun r -> match (commoncode r) : pair with
        { fst ; snd } ->
      make_response r (((%% Webserve.SC_OK %%) :
web_status)) fst snd)
    }}
    “/wait.gif” {{
      (fun req -> image (((%% Base.File.content %%) : string ->
string) “wait16.gif”) req)
    }}
    “/” (.+ $_) {{ main _2 }}
  }};;
  *normal* = 2009;;
```

Several innovative features must be noted, that contrast with classical solutions. Firstly, to reference an element in the document, we write:

$“nom_de_l'élément”

Also, and more importantly, use of a database is transparent for the programmer, who does not need to handle table creation or relations between tables. Storing a value in the base (on the server) is simply the matter of invoking the following operation:

[|“wiki”/name|]=x;

Conversely, to read a value stored in the database, the developer only needs to write

[|“wiki”/name|]

Therefore, we obtain a syntax that is both concise and expressive, without useless redundancies, and which contributes to reducing the risk of bugs. Moreover, the program is analyzed statically during compilation. This offers numerous advantages: the generated HTML code is validated; the programmer does not need to write a single line of JavaScript and the generated JavaScript is also validated. In addition, the structure of data in the database is optimized with respect to the requests that are performed.

1.3. Embodiment: Integrated Development Environment for Client/Server Applications

This embodiment describes the construction by the process according to the invention of an integrated development environment for computer software. Said development environment constitutes both a product obtained with the process according to the invention and a tool that permits use of the process according to the invention.

A development environment is developed as a client/server application. This allows one development environment server application to serve several users. The client we have developed is based on the Eclipse platform.

The features managed by the server are the following:
syntax coloring, in particular through the method detailed in the corresponding embodiment. Grammars used for source languages are incremental. Thus, only portions of the code that really need to be parsed are effectively parsed. One of the particularities made possible by the invention is to use the same grammar for the whole toolchain. In particular, the grammar for the colorizer is the same as that of the compiler. There is no duplication between code and no risk of mismatch between colors and parsing of the code by the compiler, as it often happens nowadays;
detection and display of the set of data types and functions;
real-time, incremental typing of the code.

This is the first realization of a strong static type system combined with an incremental code verifier—something made possible by the invention. This combination offers the following features:
data types do not need to be specified manually;
data types are inferred statically;
consistency of manipulation of data types is automatically checked for the whole program.

Thus, actions by developers may be transmitted to the server and from the server to other developers who may be interested by current modifications.

Moreover, the server handles the history of versions, in a manner transparent from developers, by storing code in the database defined previously. In addition, by combining this development server and the embodiment detailed previously (“multiple syntaxes”), developers with sufficient access rights may access sections of the code of other developers with a syntax of their own choosing.

Finally, the mechanisms of long-term storage and history provided by the functional database allows the development environment to visualize the modifications to source code. Indeed, according to the invention, all data is stored in the history of the database. Since source code is a set of data (the words of the source code), it is also subject to database history. Therefore, the invention makes it possible to follow the evolution of source code as a graph, for instance.

Therefore, the invention makes it possible to display the successive versions of source codes of program, but also, and this is novel, to define, as a function of changes to the source code, mechanisms for tracking data present in the database.

As an example, consider a first version of an application whose source code defines a user as an object with a first name and a last name. This first version of the application is deployed and numerous users are inserted in the internal database of the application. At a later the notion of user is modified to take into account birth date. According to the state of the art, in order to avoid data loss for users that have been inserted in the first version of the application, a database migration is required. With the history mechanism of the database and the tracking of source code in the development environment, the invention ensures that modification to the database is not required. Indeed, while compiling the new program, the compiler is aware that the definition of user has changed and is able to read the database consequently. This mechanism considerably improves flexibility of application development.

1.4. Embodiment: Specification Language SL

In order to simplify further application development, the process according to the invention contains the construction of a specification language named SL.

This specification language is built from a high-level language such as AML or QML and is characterized insofar as it is not a functional programming language. Language SL translates naturally the specifications of the application, in particular the definition of data types, the definition of values of these data types stored in the database, the rules for verifying such data upon entry by a user, . . . . From these definitions, language SL also derives screens, sub-screens or user interfaces as well as navigation between such elements. Treatments upon data do not have to be specified by the user of SL and, preferably, are not. Thus language SL as obtained by the process according to the invention allows user without specific knowledge of programming to specify naturally and transparently, as a project charger, the characteristics (specifications) of the web applications that fits her needs and constraints.

The construction of language SL is based on record datatypes as follows:
character strings;
character strings with guards;
lists;
options;
paths;
tuples.

An application written with SL is automatically generated by the process according to the invention by the following sequence of compilations: SL→AML→QML→PML.

Language SL is built by eliminating functional values that represent computations in AML and SL uses a concise notation for the definition of types or values. For instance, consider the following extract:

identifier: login, password;

By compilation to AML, we obtain:
the definition of a type type identifier={login: string; password: string}
the definition of a value in long-term storage val identifier: identifier intmap
assuming a SQL database, the definition of a table;
assuming a PHP back-end, the definition of a variable bound to this table;
linking code (implicit in AML) between the variable and the table.

As SL is a subset of AML, information may be missing. Some such information may be inferred by compilation mechanisms known to a man of the art. For instance:
some tables create values automatically val identifier: identifier intmap
some other tables create pointer to values.

A similar mechanism allows SL to take into account links (typically, relations between tables) in a manner as transparent as possible for the user, who does not need to handle implementation details.

The source code in SL is first validated against a grammar then, if validation succeeds, compiled to AML, then to QML and finally to PML.

1.5. Embodiment: XML Parser

A parser is a computer program (or an electronic device) designed to accept as input a character string (respectively a signal) and to provide as output a boolean answer regarding the validity of the string with respect to a set of rules; if this answer is true, a data structure (generally an Abstract Syntax Tree) representing said character string.

In particular, an XML parser (XML is the eXtensible Markup Language) accepts a character string, verifies that this character string is correctly formatted with respect to the specifications of XML and, if so, builds the corresponding abstract syntax tree.

Having a correct parser is important—that is, a parser that correctly verifies whether a character string is correctly formatted. This is particularly important for error-blocking devices that can be placed in front of other devices to ensure that the input is correct and would not cause unexpected behaviors.

In a preferred embodiment of such error-blocking mechanism (whether software or electronic), the input of a numeric filter is connected to the output of the parser and the numeric filter is in charge of verifying the contents of the data structure matches domain-specific application logics, provided by the client in addition to the generic parser rules.

As one of the roles of the parser is to ensure the validity of an input, it is essential that the program itself be valid and free of bugs. The only manner of verifying formally the validity of a parser is therefore to guarantee its correct behavior for all character strings is to build a provable parser.

The provability offers the possibility of guaranteeing correction by the use of a formal proof. Such formal proof, however, is difficult to obtain. To facilitate the construction of such a proof, the process according to the invention therefore makes use of code that is as concise as possible.

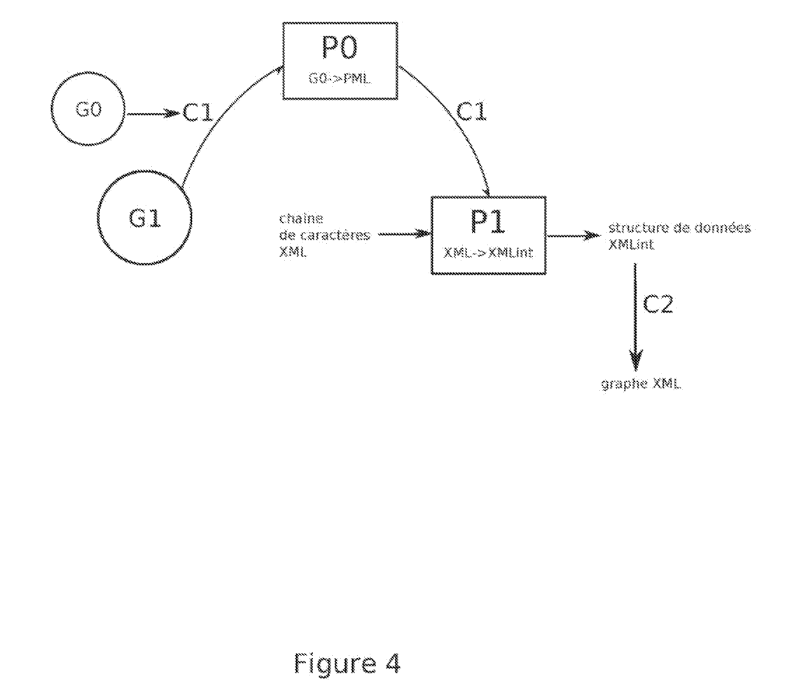

The process of parser construction is illustrated on FIG. 4. Each element used is provable and the parser makes use of a meta-grammar as well as of an intermediate representation of XML called XMLint.

We start with: a grammar G1 describing the syntax of XMLint data structures; a grammar G0 for this grammar; a parser P0 for the syntax of G0; a compiler C1 from G0 to PML. Assembling these elements, we construct a parser P1 from XML to XMLint, that accepts as input a character string formatted as XML and produces an XMLint data structure.

Preferably, XMLint uses a stack-based model, although other representations are possible. The interest of this intermediate representation is that it simplifies computations with respect to computations on the same data, should they be expressed as XML graphs. A new compiler C2 from XMLint to XML validates the initial character string and, if the string is validated, builds an XML abstract syntax tree matching the XMLint representation.

We note that this embodiment requires very few lines of code and that the language used is characterized by a reduced algebra. Thus, we reduce both the length and width of underlying trees representing the program, which simplifies the construction of a proof.

All components used are provable, therefore the parser is provable. The proof itself makes use of classical methods of static analysis.

Thus, the process according to the invention permits the construction of a provable XML parser. With adaptations that are well-known to a man of the art, the same process allows construction of other parsers, including but not limited to parsers for the IP protocol, for the HTTP protocol, for the XHTML language . . . .

Each of these parsers may also be associated to numerical filters in order to obtain provable error-blocking devices, whether software or electronic.

In another embodiment, the data structure generated by the parser (for instance, the abstract syntax tree) is used as an intermediate step which, once associated with a compiler as part of an apparatus, converts the character string from the input to another character string as an output. In this embodiment, the process according to the invention may for instance take as input a character string formatted as XML, convert it to an XML graph and output it into a format that does not accept standard XML, or in a visual format that is more convenient for a human user.

1.6. Programmable Electronic Components

The invention contributes a novel and inventive answer to the problem of bugs in programmable electronic components. Indeed, such components, which are used in all domains from consumer electronics to on-board devices for planes or to factories, are generally tested after they are programmed, so as to ensure that the features implemented are free of bugs.

Numerous methods for testing said components are known to a man of the art, and may identify bugs originating from the programmer, but not problems originating from the programming language itself. The invention solves the issue by providing a language in which micro-programs can be proved, which ensures that at least the micro-programs inserted in a component contain no bug originating from the language. Micro-programs obtained from an apparatus containing embodiment according to the invention are in particular inserted in FPGA components.

Part 2

One or more related and/or alternative embodiments related to the Description in PART 1 above are presented below. One or more of the embodiments relate to integrating a persistent storage in a programming language. Static checking on both persistent data and programs is allowed. Two of the embodiments include:
a first embodiment that defines a static type checking on a language which integrates a database, and
a second embodiment that defines a static verification of formal specifications including integrity constraints of the database and functional requirements.

The APPENDIX provides a detailed specification of additional embodiments, referred to as Opa and OpaLight. These embodiments are related to embodiments described in PART 1, referred to as PML and AML, respectively.

Generally, these embodiments provide a method for integrating a database with a programming language. These embodiments allow a full integration of any database with any programming language in such a way that strong static checks can be performed to ensure correctness of programs. This deep integration of the database gives flexibility to the programmer. Indeed, database transactions can be placed anywhere in programs, as opposed to languages that rely with static verification of database integrity constraints.

The method can deal with complex features of programming languages such as polymorphism, higher order programs, polymorphic extensible records and pattern matching. Complex database features are also supported such as concurrency, distribution and history management.

Hence, a programming language extended with a database using the disclosed method can provide simplicity, safety and security along with a powerful expressiveness.

Moreover, in such a language, persistence of data is provided in a transparent way. Indeed, the programmer can define generic functions which deal uniformly with persistent and non-persistent data.

Some embodiments provide static analysis of syntax, types, database integrity constraints and formal specifications on a powerful language including analysis of database queries and analysis of correct uses of query results. In addition, some security properties are ensured by design such as SQL injections.

This method provides a programming language able to produce certified applications such as a certified web server, a certified banking application, a certified management system for prepaid mobile cards, or any other application possibly involving a database.

An advantage of one or more of the embodiments is that they can make it possible to develop easily certified applications involving a persistent storage such as web applications. One or more embodiments can be used in an account management system, which can be viewed as a base for banking web applications or prepaid mobile cards systems using billing rules.

1-14. (canceled)

15. Process for compilation of computer programs written in a high-level programming language, comprising:
. a preliminary step before writing said program in said high-level programming language, of construction of a compiler in a core functional programming language with reduced algebra without re-assignation operation, called language PML:
a. a further preliminary step, wherein at least one programming library is written using an existing programming language;
b. a further preliminary step, wherein a functional programming interface is constructed using said at least one programming library, from a set of imperative features comprising long-term storage of information on a device, sending and receiving packets on a network, analysis of a data stream;
c. a further preliminary step of construction of at least one compiler for a high-level programming language by merging or said interfaces into the features of said language PML;
d. a step of creation of said computer program from said high-level programming language comprising a succession of compilation steps using said at least one compiler for said high-level programming language.

16. The process for compilation according to claim 15, further comprising one step of integration inside an electronic or software component of said created computer program.

17. The process for compilation according to claim 15, wherein said computer program written in said high-level programming language is an XML parser and wherein said imperative feature of analysis of a data stream is a feature of analysis and verification of an XML file.

18. The process for compilation according to claim 15, wherein at least one of said at least one programming library comprises a set of primitives for specifying access to data of a database in a high-level programming language, permitting said long-term information storage on a device without requiring a third-party database management application.

19. The process according to claim 18, wherein the data, data structures and application states of said computer program make use of long-term storage, through the use of at least one data structure having the same representation in memory and on a storage device.

20. The process according to claim 15, wherein said step of creation of said computer program further comprises one step of static analysis of the source code of said computer program before its compilation, allowing said computer program to be optimized and/or proved formally.

21. The process according to claim 15, wherein said during compilation, the compiler automatically determines which indices must be generated to reply to implicit requests in the database.

22. The process according to claim 15, wherein said at least one library permit implementing features absent from said language PML and use of said at least one library by said computer program maintains the features of said language PML, including features belonging to the group comprising: functional programming characteristic of said language; provability of said language; long-term storage of data manipulated.

23. Process according to claim 15, wherein said at least one library permits treating network exchanges by integrating at least two primitives for reading and writing data on communication ports and wherein said computer program is a web service application.

24. Process according to claim 23, wherein a unique binary is compiled from a unique source language and said unique compiled binary generates HTML, CSS and JavaScript code as well as compiled requests for accessing data.

25. Process according to claim 15, further comprising one step of construction of a specification language without the characteristics of functional programming, wherein programs written in said specification language are compiled to said high-level programming language.

26. Apparatus for compiling a computer program written in a high-level programming language, comprising:
e. means of compiling said computer program, comprising means of constructing a compiler for a core functional programming language, with reduced algebra, without re-assignation operation, said language PML;
f. further means of compiling said computer program, comprising means of writing at least one library in an existing language;
g. further means of compiling said computer program, comprising means of constructing functional interfaces based on said at least one library, for features belonging to a group containing at least: long-term storage of information on a device, emission and reception of packets on a network, analysis of a data stream;
h. further means of compiling said computer program, comprising the means of construction of at least one compiler for a high-level programming language by integration of said interfaces in the features of language PML;
i. further means of compiling said computer program, comprising means of creating said computer program from said high-level programming languages using the means provided by said at least one compiler.

27. Apparatus according to claim 26, wherein it further comprises means of integration in an electronic or software device of said computer program written in said high-level programming language, and means of associating one output of said electronic component to a filter or converter component.

28. Apparatus according to claim 26 wherein said computer program is implemented as part of an electronic component such as a programmable FPGA electronic component.
